(19) United States
(12) Patent Application Publication
(10) Pub. No.: US 2026/0152173 A1
(43) Pub. Date: Jun. 4, 2026

(54) VEHICLE CONTROL DEVICE, VEHICLE CONTROL METHOD, AND STORAGE MEDIUM

(71) Applicant: TOYOTA JIDOSHA KABUSHIKI KAISHA, Toyota-shi (JP)

(72) Inventors: Takayuki IWAMOTO, Sunto-gun (JP); Daisuke SATO, Sunto-gun (JP)

(73) Assignee: TOYOTA JIDOSHA KABUSHIKI KAISHA, Toyota-shi (JP)

(21) Appl. No.: 19/375,425

(22) Filed: Oct. 31, 2025

(30) Foreign Application Priority Data
Dec. 2, 2024 (JP) 2024-209559

(51) Int. Cl. B60W 30/02; B60W 50/00

(52) U.S. Cl. CPC B60W 30/02; B60W 50/00; B60W 2050/0005; B60W 2050/0083; B60W 2520/105; B60W 2520/14; B60W 2540/106; B60W 2540/18

(57) ABSTRACT

The vehicle control device estimates a current vehicle state after a lapse of a predetermined time based on a control request of an actuator of the vehicle 1 and a current vehicle state, calculates a guard reference value corresponding to a current vehicle state after a lapse of a predetermined time, executes a delay process on the guard reference value, calculates a limit value of a control request of the actuator based on the delay process guard reference value which is a guard reference value after the delay process is executed, and calculates a guard control request which is a control request of the actuator that does not exceed the limit value of the control request of the actuator based on the control request of the actuator and the limit value of the control request of the actuator.

### CROSS-REFERENCE TO RELATED APPLICATION

This application claims priority to Japanese Patent Application No. 2024-209559 filed on Dec. 2, 2024. The disclosure of the above-identified application, including the specification, drawings, and claims, is incorporated by reference herein in its entirety.

### BACKGROUND

### 1. Technical Field

The present disclosure relates to a vehicle control device, a vehicle control method, and a storage medium.

### 2. Description of Related Art

Japanese Unexamined Patent Application Publication No. 2023-135042 (JP 2023-135042 A) describes a technique of suppressing a sudden change in a turning angle made when a vehicle speed is switched from a state of being equal to or less than a predetermined speed to a state of being more than the predetermined speed. According to the technique described in JP 2023-135042 A, a sudden change in the turning angle made when the vehicle speed is switched from a state of being equal to or less than the predetermined speed to a state of being more than the predetermined speed is suppressed. In a state in which the vehicle speed is equal to or less than the predetermined speed, the upper limit value of the magnitude of the target value of the turning angle is restricted to the smaller side. When the vehicle speed shifts from a state of being equal to or less than the predetermined speed to a state of being more than the predetermined speed, the target value of the turning angle is gradually changed to a value that is not restricted. That is, a difference is provided between the limit value (upper limit value) of the magnitude of the target value of the turning angle at the time when the vehicle speed is equal to or less than the predetermined speed and the limit value (upper limit value) of the magnitude of the target value of the turning angle at the time when the vehicle speed is switched from a state of being equal to or less than the predetermined speed to a state of being more than the predetermined speed. This suppresses a sudden change in the target value of the turning angle.

### SUMMARY

In order to obtain the reliability of the limit value, it is considered necessary to obtain the reliability of a reference value (the vehicle speed in the technique described in JP 2023-135042 A) that is used to calculate the limit value. In the technique described in JP 2023-135042 A, a process for ensuring the reliability of the reference value is not performed. In some cases, a sensor that detects a reference value (vehicle speed), a control device that calculates a reference value (target vehicle speed), or the like fails. In this case, in the technique described in JP 2023-135042 A, there is a possibility that an abnormal value of the target value of the turning angle is output during a period until such a failure is detected.

In view of the above, an object of the present disclosure is to provide a vehicle control device, a vehicle control method, and a program capable of suppressing the possibility that an abnormal value is output at the time of a failure.

(1) One aspect of the present disclosure provides a vehicle control device including:
a read-ahead processing unit that estimates, based on a control request for an actuator of a vehicle and a current vehicle state, the current vehicle state after lapse of a predetermined time, and that calculates a guard reference value corresponding to the current vehicle state after the lapse of the predetermined time;
a delay processing unit that executes delay processing for the guard reference value calculated by the read-ahead processing unit;
an output guard value calculation processing unit that calculates a limit value for the control request for the actuator based on a post-delay-processing guard reference value that is the guard reference value after the delay processing executed by the delay processing unit; and
a post-guard control request calculation processing unit that calculates a post-guard control request based on the control request for the actuator and the limit value calculated by the output guard value calculation processing unit, the post-guard control request being the control request for the actuator not exceeding the limit value.

(2) In the vehicle control device according to (1), the read-ahead processing unit may convert the current vehicle state after the lapse of the predetermined time into reference information, and calculate the guard reference value corresponding to the reference information.

(3) In the vehicle control device according to (1), the delay processing unit may execute the delay processing by executing a process of determining the guard reference value when the predetermined time continues.

(4) One aspect of the present disclosure provides a vehicle control method including:
a vehicle control device estimating, based on a control request for an actuator of a vehicle and a current vehicle state, the current vehicle state after lapse of a predetermined time, and calculating a guard reference value corresponding to the current vehicle state after the lapse of the predetermined time;
the vehicle control device executing delay processing for the guard reference value calculated;
the vehicle control device calculating a limit value for the control request for the actuator based on a post-delay-processing guard reference value that is the guard reference value after execution of the delay processing; and
the vehicle control device calculating a post-guard control request based on the control request for the actuator and the limit value calculated, the post-guard control request being the control request for the actuator not exceeding the limit value.

(5) One aspect of the present disclosure provides a non-transitory storage medium storing a program causing a processor to execute a process including:
a vehicle control device estimating, based on a control request for an actuator of a vehicle and a current vehicle state, the current vehicle state after lapse of a predetermined time, and calculating a guard reference value corresponding to the current vehicle state after the lapse of the predetermined time;
executing delay processing for the guard reference value calculated;
calculating a limit value for the control request for the actuator based on a post-delay-processing guard reference value that is the guard reference value after execution of the delay processing; and
calculating a post-guard control request based on the control request for the actuator and the limit value calculated, the post-guard control request being the control request for the actuator not exceeding the limit value.

According to the present disclosure, it is possible to suppress the possibility that an abnormal value is output at the time of a failure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a vehicle 1 to which a vehicle control device 13 according to a first embodiment is applied;

FIG. 2 is a diagram illustrating an example of a flow of data in the vehicle 1 illustrated in FIG. 1;

FIG. 3 is a diagram illustrating an exemplary relation between a limit value of a control request of the actuator 14 calculated by the output guard value calculation processing unit 3C-2 and a reference value for guard after delay processing output from the delay processing unit 3B-2;

FIG. 4 is a diagram illustrating an exemplary vehicle 1 to which the vehicle control device 13 according to the fourth embodiment is applied; and

FIG. 5 is a flowchart for describing an example of processing executed by the processor 133 of the vehicle control device 13 according to the fourth embodiment.

### DETAILED DESCRIPTION OF EMBODIMENTS

Hereinafter, embodiments of a vehicle control device, a vehicle control method, and a program according to the present disclosure will be described with reference to the drawings.

### First Embodiment

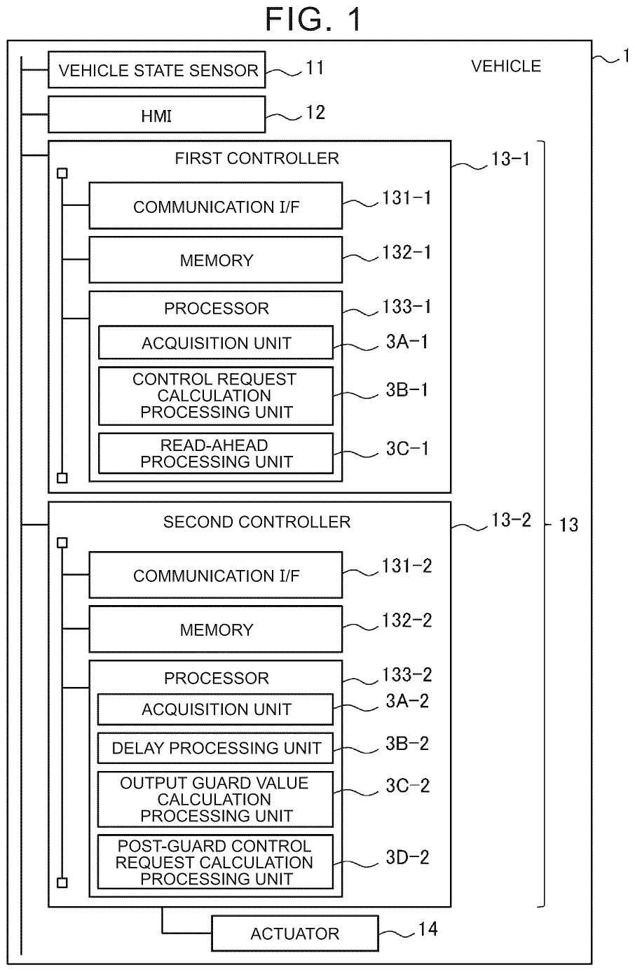

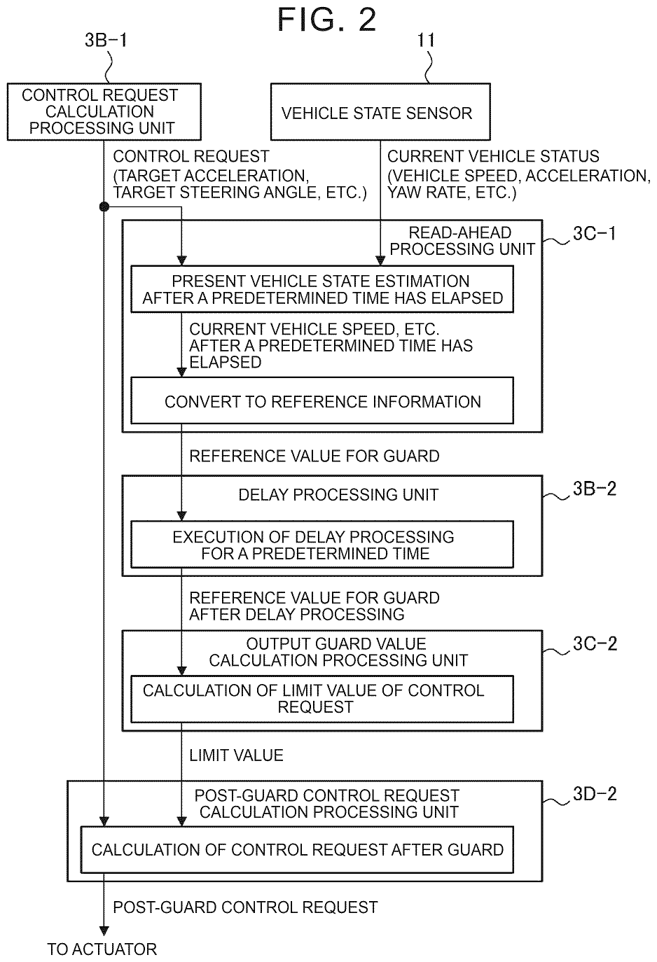

FIG. 1 is a diagram illustrating an example of a vehicle 1 to which the vehicle control device 13 according to the first embodiment is applied. FIG. 2 is a diagram illustrating an example of a flow of data in the vehicle 1 illustrated in FIG. 1. In the embodiments illustrated in FIGS. 1 and 2, the vehicle 1 includes a vehicle state sensor 11, a HMI (Human Machine Interface) 12, a vehicle control device 13, and an actuator 14.

The vehicle state sensor 11 detects (estimates) the current state (current vehicle state) of the vehicle 1, and transmits the current vehicle state to the vehicle control device 13. The vehicle state sensor 11 includes a vehicle speed sensor, an acceleration sensor, a yaw rate sensor, and the like.

HMI 12 has a function of accepting various operations of the driver of the vehicle 1, and transmits a signal indicating the operation of the driver of the vehicle 1 to the vehicle control device 13. HMI 12 includes an accelerator pedal (and a sensor that detects the operation amount thereof), a steering (and a steering angle sensor), a brake pedal (and a sensor that detects the operation amount thereof), and the like.

In the example illustrated in FIGS. 1 and 2, the vehicle control device 13 controls the actuator 14 based on the present vehicle state transmitted from the vehicle state sensor 11, a signal indicating an operation of the driver of the vehicle 1 transmitted from HMI 12, and the like. The actuator 14 is, for example, a drive actuator, a steering actuator, a braking actuator, or the like. The vehicle control device 13 includes a first control device 13-1 and a second control device 13-2.

The first control device 13-1 is constituted by a control stage ECU (Electronic Control Unit). The first control device 13-1 includes a communication interface (I/F) 131-1, a memory 132-1, and a processor 133-1. The communication interface 131-1 includes interface circuitry for connecting the first control device 13-1 to the vehicle state sensor 11, HMI 12, the second control device 13-2, and the like. The memory 132-1 stores programs and various types of data used in processing executed by the processor 133-1. The processor 133-1 has a function as an acquisition unit 3A-1, a function as a control request calculation processing unit 3B-1, and a function as a read-ahead processing unit 3C-1.

The acquisition unit 3A-1 acquires the present vehicle state transmitted from the vehicle state sensor 11 and a signal indicating the driver's manipulation of the vehicle 1 transmitted from HMI 12.

The control request calculation processing unit 3B-1 calculates a control request of the actuator 14 on the basis of a signal indicating an operation of the driver of the vehicle 1 acquired by the acquisition unit 3A-1.

In the first embodiment in which the acquisition unit 3A-1 acquires a signal indicating an operation amount of the accelerator pedal as a signal indicating an operation of the driver of the vehicle 1, the control request calculation processing unit 3B-1 calculates a target acceleration as a control request of the actuator 14 (drive actuator).

In the second embodiment in which the acquisition unit 3A-1 acquires a signal indicating the detection result of the steering angle sensor as a signal indicating the operation of the driver of the vehicle 1, the control request calculation processing unit 3B-1 calculates the target steering angle as a control request of the actuator 14 (steering actuator).

The read-ahead processing unit 3C-1 estimates the current vehicle state after a predetermined time has elapsed based on the control request of the actuator 14 calculated by the control request calculation processing unit 3B-1 and the current vehicle state acquired by the acquisition unit 3A-1. The control request of the actuator 14 is a target acceleration, a target steering angle, or the like. Currently, the vehicle state is a vehicle speed, acceleration, yaw rate, or the like.

In the first embodiment in which the acquisition unit 3A-1 acquires a signal indicating the operation amount of the accelerator pedal as a signal indicating the operation of the driver of the vehicle 1, the read-ahead processing unit 3C-1 estimates, for example, the vehicle speed, the acceleration, and the like after the lapse of a predetermined time as the present vehicle condition after the lapse of a predetermined time.

In the second embodiment in which the acquisition unit 3A-1 acquires a signal indicating the detection result of the steering angle sensor as a signal indicating the operation of the driver of the vehicle 1, the read-ahead processing unit 3C-1 estimates, for example, a yaw rate after a lapse of a predetermined time as a current vehicle state after a lapse of a predetermined time.

Further, the read-ahead processing unit 3C-1 calculates a guard reference value corresponding to the present vehicle state (vehicle speed, acceleration, yaw rate, and the like) after a predetermined period of time has elapsed. More specifically, the read-ahead processing unit 3C-1 converts the present vehicle condition (vehicle speed, acceleration, yaw rate, and the like) after a predetermined period of time has elapsed into reference information, and calculates a guard reference value corresponding to the reference information.

The first control device 13-1 transmits the control request of the actuator 14 calculated by the control request calculation processing unit 3B-1 and the guard-reference-value calculated by the read-ahead processing unit 3C-1 to the second control device 13-2.

The second control device 13-2 is constituted by an output stage ECU and is arranged, for example, in the actuator 14. The second control device 13-2 includes a communication interface 131-2, a memory 132-2, and a processor 133-2. The communication interface 131-2 includes interface circuitry for connecting the second control device 13-2 to the vehicle state sensor 11, HMI 12, the first control device 13-1, the actuator 14, and the like. The memory 132-2 stores programs and various types of data used in processing executed by the processor 133-2. The processor 133-2 has a function as an acquisition unit 3A-2, a function as a delay processing unit 3B-2, a function as an output guard value calculation processing unit 3C-2, and a function as a post-guard control request calculation processing unit 3D-2.

The acquisition unit 3A-2 obtains a control request of the actuator 14 and a guard reference value transmitted from the first control device 13-1.

The delay processing unit 3B-2 performs delay processing on the guard reference value acquired by the acquisition unit 3A-2 (that is, the guard reference value calculated by the read-ahead processing unit 3C-1), and outputs the guard reference value after the delay processing. More specifically, the delay processing unit 3B-2 performs delay processing for the “predetermined period” used in the read-ahead processing unit 3C-1 on the guard-reference-value acquired by the acquisition unit 3A-2.

The output guard value calculation processing unit 3C-2 calculates a limit value of the control requirement of the actuator 14 based on the post-delay processing guard reference value output from the delay processing unit 3B-2. The post-delay processing guard reference value outputted from the delay processing unit 3B-2 is a post-delay processing guard reference value which is a guard reference value after the delay processing is executed by the delay processing unit 3B-2.

In the first embodiment in which the acquisition unit 3A-1 acquires a signal indicating the operation amount of the accelerator pedal as a signal indicating the operation of the driver of the vehicle 1, the output guard value calculation processing unit 3C-2 calculates a limit value of the target acceleration as a limit value of the control requirement of the actuator 14.

In the second embodiment in which the acquisition unit 3A-1 acquires a signal indicating the detection result of the steering angle sensor as a signal indicating the operation of the driver of the vehicle 1, the output guard value calculation processing unit 3C-2 calculates a limit value of the target steering angle as a limit value of the control request of the actuator 14.

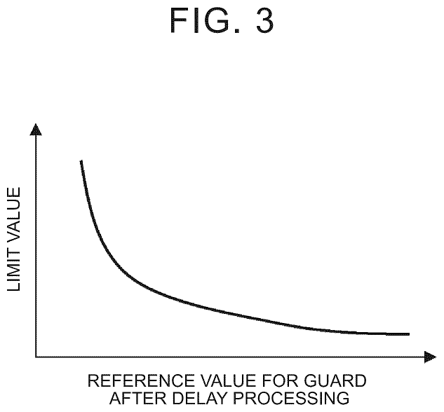

FIG. 3 is a diagram illustrating an exemplary relation between a limit value (vertical axis in FIG. 3) of a control request of the actuator 14 calculated by the output guard value calculation processing unit 3C-2 and a reference value for guard after delay processing (horizontal axis in FIG. 3) output from the delay processing unit 3B-2. In the example illustrated in FIG. 3, the relationship between the limit value of the control request of the actuator 14 and the reference value for the guard after the delay process is set so that the limit value of the control request of the actuator 14 decreases as the reference value for the guard after the delay process increases. Specifically, in the example shown in FIG. 3, the relationship between the limit value of the control request of the actuator 14 and the reference value for the guard after the delay processing is set so that the inclination of the limit value of the control request of the actuator 14 with respect to the reference value for the guard after the delay processing is reduced as the reference value for the guard after the delay processing is increased.

In the exemplary embodiments illustrated in FIGS. 1 and 2, the output guard value calculation processing unit 3C-2 uses a multi-dimensional map corresponding to the relation between the limit value of the control requirement of the actuator 14 illustrated in FIG. 3 and the reference value for guard after the delay processing, for example. Accordingly, the limit value of the control requirement of the actuator 14 is calculated based on the post-delay-processing guard reference value outputted from the delay processing unit 3B-2. That is, the limit value of the control requirement of the actuator 14 corresponding to the post-delay processing guard reference value outputted from the delay processing unit 3B-2 is selected from the multi-dimensional map.

The post-guard control request calculation processing unit 3D-2 calculates a post-guard control request that is a control request of the actuator 14 that does not exceed the limit of the control request of the actuator 14. The post-guard control request is calculated based on the control request of the actuator 14 acquired by the acquisition unit 3A-2 and the limit value of the control request of the actuator 14 calculated by the output guard value calculation processing unit 3C-2. The control request of the actuator 14 acquired by the acquisition unit 3A-2 is a control request of the actuator 14 calculated by the control request calculation processing unit 3B-1.

Specifically, the control request of the actuator 14 calculated by the control request calculation processing unit 3B-1 may be equal to or less than the limit value of the control request of the actuator 14 calculated by the output guard value calculation processing unit 3C-2. In this case, the post-guard control request calculation processing unit 3D-2 calculates the control request of the actuator 14 calculated by the control request calculation processing unit 3B-1 as the post-guard control request.

On the other hand, due to, for example, a failure of the control request calculation processing unit 3B-1, the control request of the actuator 14 calculated by the control request calculation processing unit 3B-1 may exceed the limit value of the control request of the actuator 14 calculated by the output guard value calculation processing unit 3C-2. In this case, the post-guard control request calculation processing unit 3D-2 calculates the limit value of the control request of the actuator 14 calculated by the output guard value calculation processing unit 3C-2 as the post-guard control request.

In the first embodiment in which the acquisition unit 3A-1 acquires a signal indicating the operation amount of the accelerator pedal as a signal indicating the operation of the driver of the vehicle 1, the post-guard control request calculation processing unit 3D-2 calculates a post-guard control request that does not exceed the limit value of the control request of the actuator 14. In the first example, the actuator 14 is a drive actuator, the control request is a target acceleration, and the post-guard control request is a post-guard target acceleration.

In the second example in which the acquisition unit 3A-1 acquires a signal indicating the detection result of the steering angle sensor as a signal indicating the operation of the driver of the vehicle 1, the post-guard control request calculation processing unit 3D-2 calculates a post-guard control request (post-guard target steering angle) that does not exceed the limit value of the control request (target steering angle) of the actuator 14 (steering actuator). In the second example, the actuator 14 is a steering actuator, the control request is a target steering angle, and the post-guard control request is a post-guard target steering angle.

As described above, in the embodiments illustrated in FIGS. 1 and 2, in order to select a dynamically guard reference value to be set in the output stage ECU, the present vehicle state (vehicle speed, acceleration, yaw rate, and the like) after a predetermined time has elapsed is estimated by the read-ahead processing unit 3C-1 of the control stage ECU. The output stage ECU is the second control device 13-2 and the control stage ECU is the first control device 13-1. The current vehicle state (vehicle speed, acceleration, yaw rate, and the like) after the estimated predetermined time elapses is used to calculate the guard reference value. The guard reference value is a reference value of a limit value of a control requirement of the actuator 14 calculated by the output guard value calculation processing unit 3C-2.

When the control stage ECU fails, the reliability of the control request of the actuator 14 calculated by the control request calculation processing unit 3B-1 becomes low. However, in the exemplary embodiments shown in FIGS. 1 and 2, since the delay process is performed on the guard-reference-value in the output stage ECU, it is possible to suppress the failure of the control stage ECU immediately affecting.

In some cases, the control stage ECU is configured so that the control stage ECU can reliably detect a failure of the control stage ECU. Even in such cases, abnormal values (abnormal control demands) may be outputted from the control stage ECU during a period from the failure of the control stage ECU until the failure of the control stage ECU is detected. In order to suppress the actuator being inappropriately controlled based on an abnormal control requirement output from the control stage ECU, the guard-reference output from the control stage ECU needs to be highly reliable.

Therefore, in the embodiments illustrated in FIGS. 1 and 2, as described above, the delay processing unit 3B-2 performs the delay processing on the guard reference value used for calculating the limit value of the control requirement of the actuator 14. The guard reference value used to calculate the limit value of the control requirement of the actuator 14 is a guard reference value outputted from the control stage ECU (the first control device 13-1).

That is, in the examples shown in FIGS. 1 and 2, in order to ensure the reliability of the limit value of the control request of the actuator 14, the reliability of the guard reference value is also ensured.

Therefore, in the exemplary embodiments illustrated in FIGS. 1 and 2, it is possible to suppress the possibility that an abnormal value requested for control is outputted to the actuator 14 even if the control stage ECU (the first control device 13-1) fails.

### Second Embodiment

The vehicle 1 to which the vehicle control device 13 of the second embodiment is applied is configured in the same manner as the vehicle 1 to which the vehicle control device 13 of the first embodiment described above is applied, except for the point described later.

As described above, in an example of the vehicle 1 to which the vehicle control device 13 according to the first embodiment is applied (examples illustrated in FIGS. 1 to 3), the read-ahead processing unit 3C-1 converts the present vehicle status (vehicle speed, acceleration, yaw rate, and the like) after a predetermined period of time into reference information (guard reference value). The delay processing unit 3B-2 performs delay processing on the guard reference value, and outputs the guard reference value after the delay processing. Further, the output guard value calculation processing unit 3C-2 calculates the limit value of the control requirement of the actuator 14 based on the delay-processed guard reference value and the relation shown in FIG. 3.

On the other hand, in one embodiment of the vehicle 1 to which the vehicle control device 13 of the second embodiment is applied, the read-ahead processing unit 3C-1 does not convert the present vehicle status after a predetermined period of time to reference information (guard reference value). In this case, the delay processing unit 3B-2 performs the delay processing on the present-vehicle condition after the predetermined period of time has elapsed. The output guard value calculation processing unit 3C-2 calculates a limit value of a control requirement of the actuator 14. The limit value of the control request of the actuator 14 is calculated on the basis of the current vehicle state after the lapse of the predetermined time after the delay processing is executed and the relationship between the limit value of the control request of the actuator 14 and the current vehicle state after the lapse of the predetermined time after the delay processing is executed. In other words, in this embodiment, the present vehicle condition (vehicle speed, acceleration, yaw rate, and the like) after the lapse of the predetermined period of time estimated by the read-ahead processing unit 3C-1 is used as the guard reference value.

### Third Embodiment

The vehicle 1 to which the vehicle control device 13 of the third embodiment is applied is configured in the same manner as the vehicle 1 to which the vehicle control device 13 of the first embodiment described above is applied, except for the points described later.

As described above, in an example of the vehicle 1 to which the vehicle control device 13 of the first embodiment is applied (the example illustrated in FIGS. 1 and 2), the delay processing unit 3B-2 performs the delay processing for the “predetermined time” used in the read-ahead processing unit 3C-1 on the guard reference value calculated by the read-ahead processing unit 3C-1.

On the other hand, in an exemplary vehicle 1 to which the vehicle control device 13 according to the third embodiment is applied, the delay processing unit 3B-2 executes processing for determining the guard-reference-value when the “predetermined-time” used in the read-ahead processing unit 3C-1 continues. As a result, the delay processing for the guard reference value is executed.

### Fourth Embodiment

The vehicle 1 to which the vehicle control device 13 of the fourth embodiment is applied is configured in the same manner as the vehicle 1 to which the vehicle control device 13 of the first embodiment described above is applied, except for the point described later.

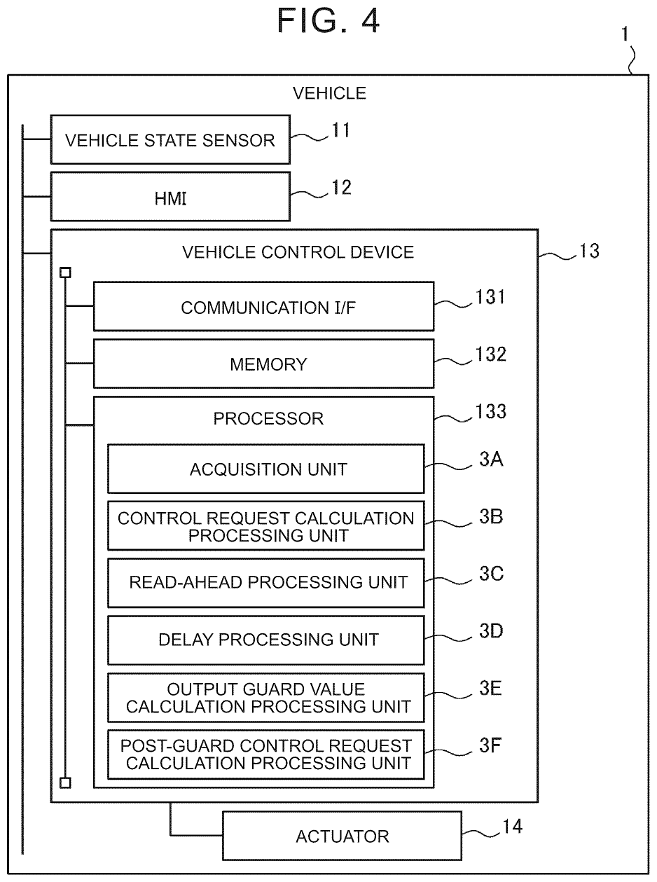

FIG. 4 is a diagram illustrating an example of the vehicle 1 to which the vehicle control device 13 according to the fourth embodiment is applied. As described above, in an example of the vehicle 1 to which the vehicle control device 13 according to the first embodiment is applied (examples shown in FIGS. 1 and 2), the vehicle control device 13 includes the first control device 13-1 and the second control device 13-2. That is, the vehicle control device 13 includes a control stage ECU corresponding to the first control device 13-1 and an output stage ECU corresponding to the second control device 13-2.

On the other hand, in an example (an example illustrated in FIG. 4) of the vehicle 1 to which the vehicle control device 13 according to the fourth embodiment is applied, the vehicle control device 13 is configured by one ECU, and includes a communication interface 131, a memory 132, and a processor 133. The processor 133 has a function as an acquisition unit 3A, a function as a control request calculation processing unit 3B, and a function as a read-ahead processing unit 3C. Further, the processor 133 includes a function as a delay processing unit 3D, a function as an output guard value calculation processing unit 3E, and a post-guard control request calculation processing unit 3F.

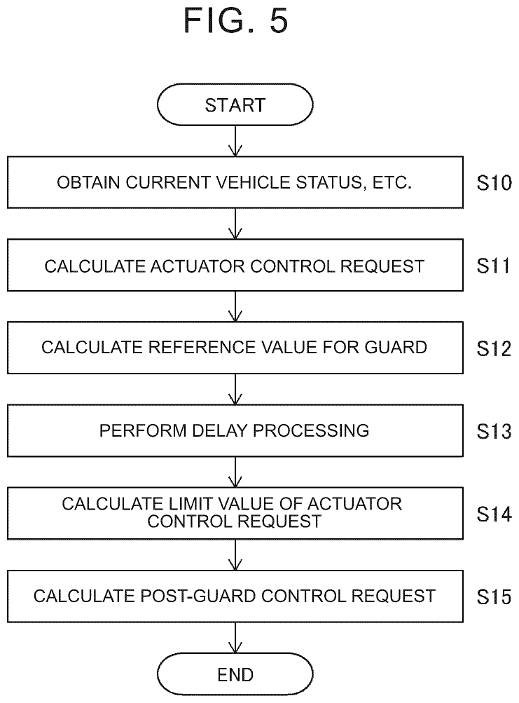

FIG. 5 is a flowchart for describing an example of processing executed by the processor 133 of the vehicle control device 13 according to the fourth embodiment. In the embodiment illustrated in FIG. 5, in S10, the acquisition unit 3A-1 acquires the present vehicle state transmitted from the vehicle state sensor 11 and a signal indicating the driver's manipulation of the vehicle 1 transmitted from HMI 12.

In S11, the control request calculation processing unit 3B calculates a control request of the actuator 14 based on a signal indicating the operation of the driver of the vehicle 1 acquired in S10.

In S12, the read-ahead processing unit 3C estimates the current vehicle state after a predetermined period of time has elapsed on the basis of the control demand of the actuator 14 calculated in S11 and the current vehicle state acquired in S10. Then, the read-ahead processing unit 3C calculates a guard reference value corresponding to the present vehicle state after a predetermined period of time has elapsed.

In S13, the delay processing unit 3D performs delay processing on the guard reference value calculated in S12, and outputs the guard reference value after the delay processing.

In S14, the output guard value calculation processing unit 3E calculates the limit value of the control requirement of the actuator 14 based on the delayed guard reference value output in S13.

In S15, the post-guard control request calculation processing unit 3F calculates the post-guard control request based on the control request of the actuator 14 calculated in S11 and the limit of the control request of the actuator 14 calculated in S14. The post-guard control request is a control request for the actuator 14 that does not exceed the limit value of the control request of the actuator 14

As described above, embodiments of the vehicle control device, the vehicle control method, and the program of the present disclosure have been described with reference to the drawings. However, the vehicle control device, the vehicle control method, and the program of the present disclosure are not limited to the above-described embodiments, and can be appropriately modified without departing from the spirit of the present disclosure. The configuration of each example of the above-described embodiment may be combined as appropriate. In each example of the above-described embodiment, the process performed in the vehicle control device 13 has been described as a software process performed by executing a program. However, the process performed by the vehicle control device 13 may be a process performed by hardware. Alternatively, the process performed in the vehicle control device 13 may be a process in which both software and hardware are combined. Further, a program stored in the memory 132 of the vehicle control device 13 may be provided and distributed by being recorded in a computer-readable storage medium such as a semiconductor memory, a magnetic recording medium, an optical recording medium, or the like. The program stored in the memory 132 of the vehicle control device 13 is a program for realizing the functions of the processor 133 of the vehicle control device 13.

What is claimed is:

1. A vehicle control device comprising:
a read-ahead processing unit that estimates, based on a control request for an actuator of a vehicle and a current vehicle state, the current vehicle state after lapse of a predetermined time, and that calculates a guard reference value corresponding to the current vehicle state after the lapse of the predetermined time;
a delay processing unit that executes delay processing for the guard reference value calculated by the read-ahead processing unit;
an output guard value calculation processing unit that calculates a limit value for the control request for the actuator based on a post-delay-processing guard reference value that is the guard reference value after the delay processing executed by the delay processing unit; and
a post-guard control request calculation processing unit that calculates a post-guard control request based on the control request for the actuator and the limit value calculated by the output guard value calculation processing unit, the post-guard control request being the control request for the actuator not exceeding the limit value.

2. The vehicle control device according to claim 1, wherein the read-ahead processing unit converts the current vehicle state after the lapse of the predetermined time into reference information, and calculates the guard reference value corresponding to the reference information.

3. The vehicle control device according to claim 1, wherein the delay processing unit executes the delay processing by executing a process of determining the guard reference value when the predetermined time continues.

4. A vehicle control method comprising:
a vehicle control device estimating, based on a control request for an actuator of a vehicle and a current vehicle state, the current vehicle state after lapse of a predetermined time, and calculating a guard reference value corresponding to the current vehicle state after the lapse of the predetermined time;
the vehicle control device executing delay processing for the guard reference value calculated;
the vehicle control device calculating a limit value for the control request for the actuator based on a post-delay-processing guard reference value that is the guard reference value after execution of the delay processing; and
the vehicle control device calculating a post-guard control request based on the control request for the actuator and the limit value calculated, the post-guard control request being the control request for the actuator not exceeding the limit value.

5. A non-transitory storage medium storing a program causing a processor to execute a process comprising:
a vehicle control device estimating, based on a control request for an actuator of a vehicle and a current vehicle state, the current vehicle state after lapse of a predetermined time, and calculating a guard reference value corresponding to the current vehicle state after the lapse of the predetermined time;
executing delay processing for the guard reference value calculated;
calculating a limit value for the control request for the actuator based on a post-delay-processing guard reference value that is the guard reference value after execution of the delay processing; and
calculating a post-guard control request based on the control request for the actuator and the limit value calculated, the post-guard control request being the control request for the actuator not exceeding the limit value.
